(19) United States
(12) Patent Application Publication
(10) Pub. No.: US 2022/0061229 A1
(43) Pub. Date: Mar. 3, 2022

(54) PORTABLE AND ELEVATED PLANTER BOX AND METHODS OF USE

(71) Applicants: Roger L. FIELDS, League City, TX (US); John K. FIELDS, Edmond, OK (US)

(72) Inventors: Roger L. FIELDS, League City, TX (US); John K. FIELDS, Edmond, OK (US)

(21) Appl. No.: 17/458,820

(22) Filed: Aug. 27, 2021

Related U.S. Application Data
(60) Provisional application No. 63/071,402, filed on Aug. 28, 2020.

(51) Int. Cl. A01G 9/02; A47G 7/04

(52) U.S. Cl. CPC A01G 9/02; A47G 7/045

(57) ABSTRACT

An elevated planter apparatus positioned above ground, includes a planter box with sides and a bottom, a plurality of aperture connectors connected to said bottom, each of said plurality of aperture connectors provides passageway therethrough, a plurality of tube connectors having a closed end, each of said plurality of tube connectors connected to one of said plurality of aperture connectors, a plurality of rods having a first rod end and a second rod end, said first rod end positioned in the ground and said second rod end inserted in one of said plurality of aperture connectors and one of said plurality of tube connectors, and thus that can be easily incorporated into existing landscaping without damaging, modifying, or changing the existing landscaping.

### CROSS-REFERENCE TO RELATED APPLICATIONS

To the full extent permitted by law, the present U.S. Non-Provisional Patent Application claims priority to and the full benefit of; U.S. Provisional Application No. 63/071,402, filed on Aug. 28, 2020, entitled “ELEVATED PLANTER BOX AND METHODS OF USE”, the contents of which is incorporated herein by reference in its entirety.

### FIELD OF THE DISCLOSURE

The present disclosure is directed to a planter box apparatus. More specifically, the present disclosure is directed to portable and elevated planter box.

### BACKGROUND

Many people enjoy gardening around their home or business. It is desirable to plant different varieties of plants as well as planting of plants with different heights to provide a sense of depth to the garden. Sometimes tall varieties of plants are not available or are out of season. In these situations, a gardener may turn to an elevated plant stand, or a gardener may want to utilize an elevated plant stand to accent a garden space.

One prior approach of an elevated plant stand having a traditional box with wooden or metal legs. One disadvantage or drawback to this approach is that the legs are visible and take away from the natural plant setting.

Another prior approach is a window box. One disadvantage or drawback to this approach is that it is necessary to drill the brick or other exterior surfaces to attach the window box to the exterior surface.

Therefore, it is readily apparent that there is a recognizable unmet need for an improved portable and elevated planter box and methods of use that may be configured to address at least some aspects of the problems discussed above common to rethreading the paper web via nozzles and chutes.

### SUMMARY

Briefly described, in an example embodiment, the present disclosure may overcome the above-mentioned disadvantages and may meet the recognized need portable and elevated planter box apparatus and methods of use, an elevated planter vertically positioned above the ground having a planter box with sides and a bottom, the bottom may have at least two apertures formed therein, a plurality of threaded connectors affixed to the at least two apertures or formed integral to the bottom, the connector having an aperture therethrough, a plurality of closed end connector, each of the tubular connector connected to one of the plurality of threaded connectors, and a plurality of rods having a first rod end and a second rod end, the first rod end positioned in the ground and the second rod end inserted in one of the tubular connectors.

Accordingly, in another aspect, the present disclosure may include an improved plant stand that can be easily incorporated into existing landscaping without damaging, modifying, or changing the existing landscaping.

Accordingly, in another aspect, the present disclosure the bottom may have at least two apertures formed therein to each receive one of the plurality of aperture connectors.

Accordingly, in another aspect, the present disclosure may include a plurality of aperture connectors are formed integral to the bottom.

Accordingly, in another aspect, the present disclosure may include a plurality of closed end tube connectors may be incorporated with the plurality of aperture connectors.

In an exemplary embodiment of the elevated planter apparatus positioned above the ground, includes a planter box with sides and a bottom, a plurality of aperture connectors connected to the bottom, the connector provides passageway therethrough the bottom, a plurality of tube connectors having a closed end, each the tubular connector connected to one of the plurality of aperture connectors, and a plurality of rods having a first rod end and a second rod end, the first rod end positioned in the ground and the second rod end inserted in one of the aperture connectors and the tube connectors.

In an exemplary embodiment of the elevated planter apparatus positioned above the ground includes a planter box with sides having a rim therearound and a bottom, a plurality of shepherd's hooks having a first hook end and a second hook end, the first hook end positioned in the ground, a plurality of attachment devices, each of the plurality of attachment devices affixed to one of the plurality of shepherd's hooks between the first hook end and the second hook end, and a plurality of connection systems, each of the plurality of connection systems removeably positioned between each of the plurality of attachment device and the rim of the planters box.

In another exemplary embodiment of the method of elevating a planter having dirt and plants above ground in a landscape, includes providing a planter box with sides and a bottom, a plurality of aperture connectors connected to the bottom, each of the plurality of aperture connectors provides passageway therethrough, a plurality of tube connectors having a closed end, each of the plurality of tube connectors connected to one of the plurality of aperture connectors, a plurality of rods having a first rod end and a second rod end, the first rod end positioned in the ground and the second rod end inserted in one of the plurality of aperture connectors and one of the plurality of tube connectors.

A feature of the present disclosure may include the less intrusive appearance of an elevated planter box since the support is not visible as in the traditional planter box with wooden or metal legs.

A feature of the present disclosure may include providing a quick application to elevate the planter box without drilling brick or other exterior surfaces to attach the window box to the exterior surface.

A feature of the present disclosure may include a portable and elevated planter box that adds height and depth to flower gardens/beds.

A feature of the present disclosure may include a portable and elevated planter box is to provide a system allowing flowers and plants to be potted and elevated or suspended above ground.

A feature of the present disclosure may include a portable and elevated planter box that may be removed and relocated to a different area.

A feature of the present disclosure may include a portable and elevated planter box having a plurality of aperture connectors rising from the bottom of planter box and a plurality of closed end tubular connectors affixed to the aperture connector.

A feature of the present disclosure may include a portable and elevated planter box that utilizes readily available rods to push into the ground and support the planter box.

A feature of the present disclosure may include a portable and elevated planter box may be produced in varying shapes, configurations, colors and sizes.

A feature of the present disclosure may include reduced assembly time and ease of placement of the apparatus in the garden.

These and other features of the portable and elevated planter box apparatus and methods of use will become more apparent to one skilled in the art from the prior Summary and following Brief Description of the Drawings, Detailed Description of exemplary embodiments thereof, and claims when read in light of the accompanying Drawings or Figures.

### BRIEF DESCRIPTION OF THE DRAWINGS

The present disclosure will be better understood by reading the Detailed Description of the Preferred and Selected Alternate Embodiments with reference to the accompanying drawing Figures, in which like reference numerals denote similar structure and refer to like elements throughout, and in which:

FIG. 1A is a bottom perspective view of the planter box of the portable and elevated planter box apparatus according to select embodiments of the instant disclosure;

FIG. 1B is a bottom perspective view of the aperture connector of the portable and elevated planter box apparatus according to select embodiments of the instant disclosure;

FIG. 1C is a top perspective view of the closed end tube of the portable and elevated planter box apparatus according to select embodiments of the instant disclosure;

FIG. 1D is a front perspective view of the support rods of the portable and elevated planter box apparatus according to select embodiments of the instant disclosure;

FIG. 2 is a front perspective assembly view of the portable and elevated planter box apparatus according to select embodiments of the instant disclosure;

FIG. 3 is a front perspective in use view of the portable and elevated planter box apparatus according to select embodiments of the instant disclosure;

FIG. 4 is a front view of a portable and elevated planter box apparatus according to select embodiments of the instant disclosure;

FIG. 5 is a partial side view of a portable and elevated planter box apparatus of FIG. 4; and

FIG. 6 is a flow diagram depicting assembly and operation of portable and elevated planter box apparatus.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

In describing the exemplary embodiments of the present disclosure, as illustrated in the figures specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

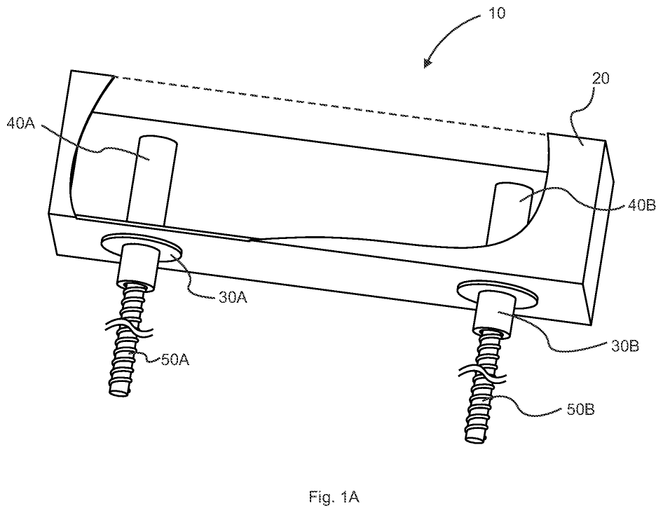

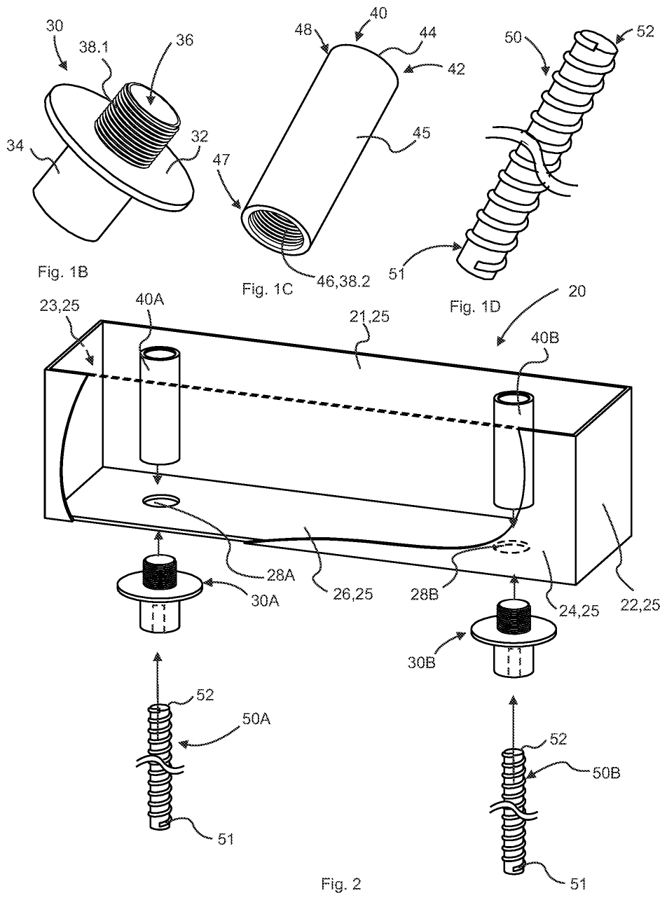

Referring now to FIGS. 1A, 1B, 1C, 1D, 2 by way of example, and not limitation, there is illustrated an example embodiment of portable and elevated planter box apparatus 10, according to this select embodiment. Referring again to FIG. 1A, portable and elevated planter box apparatus 10 may include a container, such as planter box 20 may be configured as an open top container having one or more sidewall 25, such as back or first sidewall 21, right or second sidewall 22, left or third sidewall 23, and front or fourth sidewall 24. Moreover, planter box 20 may include closed bottom or bottom 26. In one embodiment, bottom 26 may include one or more or a pair or plurality of holes, such as box aperture 28, 28A, 28B formed therein to each receive aperture connector 30.

It is contemplated herein that planter box 20 may be configured in any variety of shapes, including but not limited to cylinder, square, rectangle, and the like, sizes, and constructed of a variety of materials including but not limited to plastic, metal, wood and the like.

It is further contemplated herein that planter box 20 may be utilized to contain or house soil, water, and plants, such as decorative plants, flowers, vegetables, fruit, and the like.

Referring again to FIG. 1B, portable and elevated planter box apparatus 10 may include aperture connector 30, 30A, 30B. In one embodiment aperture connector 30 may include base 32 and stub 34 formed perpendicular to base 32 and both having a passageway 36 therethrough to create a reinforced aperture therethrough bottom 26. One or more aperture connector 30 may be affixed to and positioned therethrough bottom 26, such as box aperture 28. In an alternate embodiment, one or more aperture connector 30 may be integrated therein or formed in bottom 26. Stub 34 may include first part of connector system 38.1, including but not limited threaded 38.1 (preferably exterior threaded), friction fit, adhesive, lock or latch, pin and groove, and the like 38.1.

It is contemplated herein that bottom 26 may have at least two apertures may be affixed thereto to each receive one of the plurality of aperture connector 30.

It is further contemplated herein that bottom 26 may have at least two apertures formed integral therein to each receive one of the plurality of aperture connector 30.

It is still further contemplated herein that aperture connector 30 may be configured in any variety of shapes, including but not limited to cylinder, square, rectangle, and the like, sizes, and constructed of a variety of materials including but not limited to plastic, metal, and the like.

Referring again to FIG. 1C, portable and elevated planter box apparatus 10 may include tube connector with a closed end, such as closed end tube 40, 40A, 40B. In one embodiment closed end tube 40 may include conduit, such as tube 45 having passageway 46 therethrough with first end 47 and second end 48 where first end 47 may be open to enable access to passageway 46 and closed end 44 to stop passageway therethrough. First end 47 may include second part of connection system 38.2, including but not limited threaded 38.2 (preferably interior threaded), friction fit, adhesive, lock or latch, pin and groove, and the like 38.2.

It is contemplated herein that first part of connection system 38.1 and second part of connection system 38.2 may be utilized to engage and removeably affix closed end tube 40 to aperture connector 30 to provide one or more aperture and support tube affixed to or around bottom 26, preferably in a spaced apart configuration. In a preferred embodiment, threaded 38.2 (preferably interior threaded) of closed end tube 40 is threaded to threaded 38.1 (preferably exterior threaded) of aperture connector 30.

It is further contemplated herein that closed end tube 40 may be configured in any variety of shapes, including but not limited to cylinder, square, rectangle, and the like, sizes, and constructed of a variety of materials including but not limited to plastic, metal, and the like.

Referring again to FIG. 1D, portable and elevated planter box apparatus 10 may include one or more rods such as elongated support 50 (of various lengths) having first rod end, such as first support end 51 and second rod end, such as second support end 52. In one embodiment elongated support 50 may include smaller cross-section dimension elongated support 50 sized to be inserted through aperture connector 30 and closed end tube 40 to vertically support and elevate portable and elevated planter box apparatus 10.

It is contemplated herein to assemble portable and elevated planter box apparatus 10, an equal number of elongated supports 50 may have second support end 52 inserted through aperture connector 30 and closed end tube 40 to vertically support and elevate elevated planter box apparatus 10.

It is further contemplated herein that elongated supports 50 may be configured in any variety of shapes, including but not limited to cylinder, square, rectangle, and the like, sizes, and constructed of a variety of materials including but not limited to plastic, metal, wood and the like, such as rebar, PVC, stake.

Referring now to FIG. 2, by way of example, and not limitation, there is illustrated an example embodiment of assembly view of the portable and elevated planter box apparatus 10, according to this select embodiment. One or more aperture connector 30 may be affixed to (or integral to bottom 28) and positioned therethrough bottom 26. Connector system or plurality of connection systems includes a plurality of first part of connection system 38.1 and second part of connection system 38.2 may be utilized to removeably affix closed end tube 40 to aperture connector 30, such as and second part of connection system 38.2 (preferably interior threaded) of closed end tube 40 is threaded to threaded 38.1 (preferably exterior threaded) of aperture connector 30 about bottom 28. Second support end 52 of elongated supports 50 may be inserted through aperture connector 30 and closed end tube 40 to secure elongated supports 50 to planter box 20. First support end 51 of elongated supports 50 may be pushed or inserted into ground G to support planter box 20 in an elevated position at height H above ground G.

It is contemplated herein that portable and elevated planter box apparatus 10 can be easily incorporated into existing landscaping without damaging, modifying, or changing the existing landscaping.

It is further contemplated herein that portable and elevated planter box apparatus 10 may be easily moved from one location to the next without damaging, modifying, or changing the existing landscaping.

It is still further contemplated herein that portable and elevated planter box apparatus 10 may have elongated supports 50 of varying heights to change the height of portable and elevated planter box apparatus 10 in the landscape.

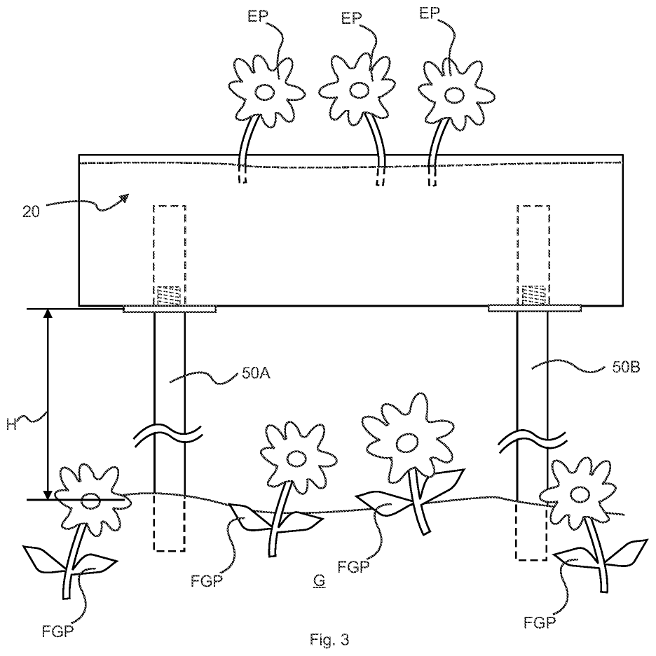

Referring now to FIG. 3, by way of example, and not limitation, there is illustrated an example embodiment of in use view of the portable and elevated planter box apparatus 10, according to this select embodiment may be filled with dirt and plants to be elevated, elevated plants EP. Here, each of second support end 52 of elongated supports 50 may be inserted through aperture connector 30 and closed end tube 40 to secure elongated supports 50 to planter box 20. First support end 51 of elongated supports 50 may be pushed or inserted into ground G behind foreground plants FGP to support planter box 20 in an elevated position at height H above ground G.

It is contemplated herein that portable and elevated planter box apparatus 10 may support elevated plants EP in an elevated position above foreground plants FGP.

It is contemplated herein that portable and elevated planter box apparatus 10 can be easily incorporated into existing landscaping without damaging, modifying, or changing the existing landscaping.

It is further contemplated herein that portable and elevated planter box apparatus 10 may be easily moved from one location to the next without damaging, modifying, or changing the existing landscaping.

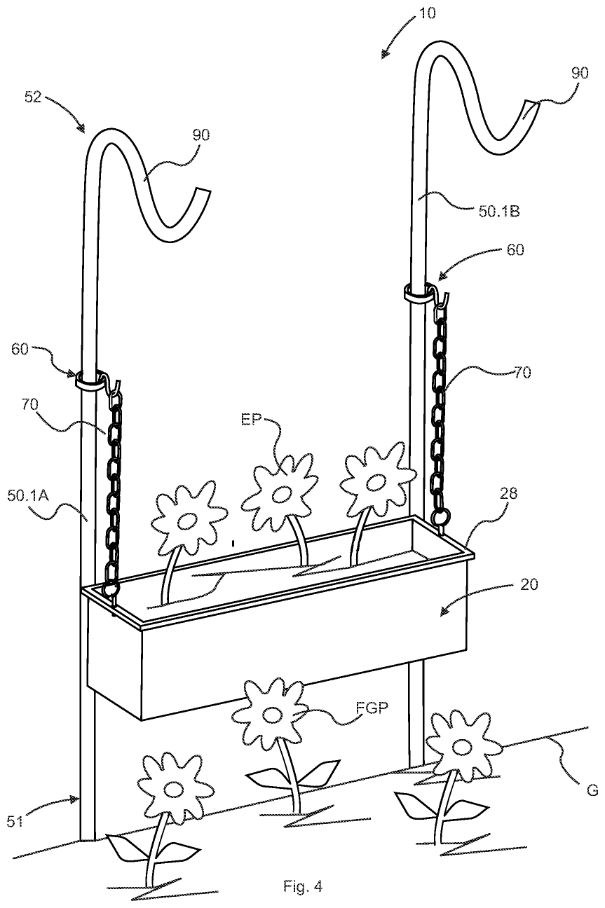

Referring now to FIG. 4, by way of example, and not limitation, there is illustrated an example embodiment of in use view of the portable and elevated planter box apparatus 10.1 according to this select embodiment. Portable and elevated planter box apparatus 10.1 may include a container, such as planter box 20 may be configured as an open top container having one or more sidewall 25 and include closed bottom or bottom 26. One or more sidewall 25 may include an edge, such as flared rim 28.

Portable and elevated planter box apparatus 10.1 may be elevated and supported by one or more elongated support 50.1, such as two elevated Shepherd's Hooks 50.1A, 50.1B (of various lengths) having first hook end, such as first support end 51.1 and second hook end, such as second support end 52.1. A plurality of attachment devices, such as each of one or more elongated support 50.1 may include attachment device 60 positioned between first support end 51.1 and second support end 52.1. Attachment device 60 may include J-hook affixed or welded to elongated support 50.1, hose clamp secured around elongated support 50.1 or other like attachment device.

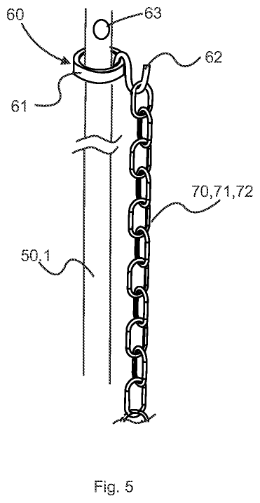

Referring now to FIG. 5, by way of example, and not limitation, there is illustrated an example embodiment of the portable and elevated planter box apparatus 10.1 according to this select embodiment. Attachment device 60 may be utilized with connection system 70 to connect portable and elevated planter box apparatus 10.1 to one or more elongated support 50.1, such as two elevated Shepherd's Hooks 50.1A, 50.1B. Connection system 70 may include first connection support 71 and second connection support 72. Connection system 70 may include a chain connected to attachment device 60 in the middle to form first connection support 71 and second connection support or other like connection supports like cable, rope, twine. Using chain allows the elevation or height of planter box 20 to be easily adjusted. Connection system 70 may be utilized to connect to planter box 20 at one or more sidewall 25, bottom 26, or flared rim 28.

It is contemplated herein that portable and elevated planter box apparatus 10.1 can be easily incorporated into existing landscaping without damaging, modifying, or changing the existing landscaping.

It is further contemplated herein that portable and elevated planter box apparatus 10.1 may be easily moved from one location to the next without damaging, modifying, or changing the existing landscaping.

It is still further contemplated herein that portable and elevated planter box apparatus 10 may have elongated supports 50.1 of varying heights to change the height of portable and elevated planter box apparatus 10 in the landscape.

It is still further contemplated herein that portable and elevated planter box apparatus 10 may include a ‘J’ or ‘S’ hook 62 connected to Shepherd's Hooks 50.1A, 50.1B via weld, adhesive, hose clamp 61 or attachment aperture 63 formed therein Shepherd's Hooks 50.1A, 50.1B.

Moreover, two elevated Shepherd's Hooks 50.1A, 50.1B may each support an additional hanging plant via upper hook 90.

It is contemplated herein that portable and elevated planter box apparatus 10.1 components may be constructed of plastic, stainless steel, aluminum, wood, or the like materials and of different dimensions. This and other materials herein may be constructed of metal, steel, alloy, or plastic or more specifically high density polyethylene or similar high tensile or strengthened materials, as these material offers a variety of forms and shapes and provide strength with reduced weight; however, other suitable materials or the like, can be utilized, provided such material has sufficient strength and/or durability as would meet the purpose described herein.

It is understood herein that various changes in the material used, shape, size, arrangement of parts, and parts are removeably connected with threads, or other rotating devices without departing from the spirit of the scope of the claims herein.

It is further understood herein that the parts and elements of this disclosure may be located or position elsewhere based on one of ordinary skill in the art without deviating from the present disclosure.

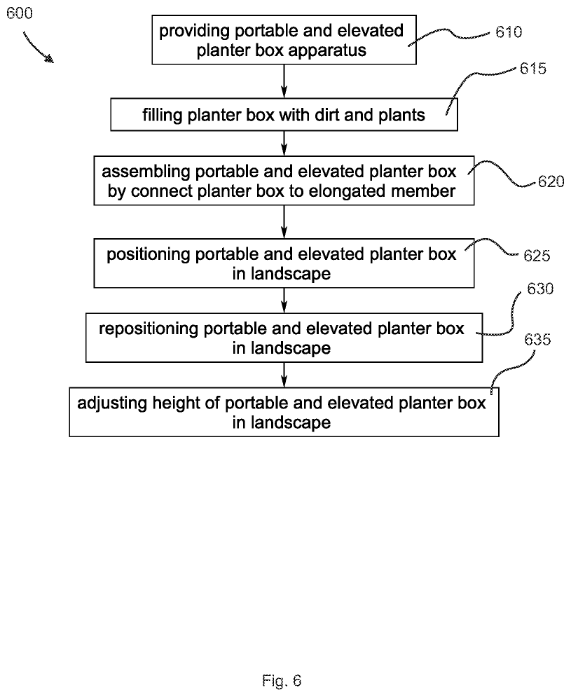

Referring now to FIG. 6, there is illustrated a flow diagram 600 of a method of assembly and operation of portable and elevated planter box apparatus 10, 10.1. In block or step 610, providing portable and elevated planter box apparatus 10, 10.1, as described above in FIGS. 1-5, to incorporate varying heights planter into existing landscaping without damaging, modifying, or changing the existing landscaping and to easily move the plater box from one location to the next without damaging, modifying, or changing the existing landscaping.

In block or step 615, filling portable and elevated planter box apparatus 10, 10.1.

In block or step 620, assembling portable and elevated planter box apparatus 10, 10.1 via second support end 52 of elongated supports 50 may be inserted through aperture connector 30 and closed end tube 40 to secure elongated supports 50 to planter box 20. Alternatively, one or more elongated support 50.1, such as two elevated Shepherd's Hooks 50.1A, 50.1B may be affixed to planter box 20 via connection system may include a chain connected to attachment device 60 in the middle of elongated support 50.1 and connected to planter box 20 at one or more sidewall 25, bottom 26, or flared rim 28.

In block or step 625, positioning portable and elevated planter box apparatus 10, 10.1 in landscape via first support end 51 of elongated supports 50/50.1 may be pushed or inserted into ground G behind foreground plants FGP to support planter box 20 in an elevated position at height H above ground G.

In block or step 630, repositioning portable and elevated planter box apparatus 10, 10.1 in a different position of landscape via first support end 51 of elongated supports 50/50.1 may be pushed or inserted into new section of ground G behind foreground plants FGP to support planter box 20 in an elevated different position at height H above ground G.

In block or step 635, adjusting height of portable and elevated planter box apparatus 10, 10.1 via selecting different length elongated supports 50 via second support end 52 of elongated supports 50/50.1 may be inserted through aperture connector 30 and closed end tube 40 to secure elongated supports 50 to planter box 20. Alternatively, one or more elongated support 50.1, such as two elevated Shepherd's Hooks 50.1A, 50.1B may be affixed to planter box 20 via connection system may include a chain connected to attachment device 60 in the middle of elongated support 50.1 and connected to planter box 20 at one or more sidewall 25, bottom 26, or flared rim 28; and elongated supports 50/50.1 via first support end 51 of elongated supports 50/50.1 may be pushed or inserted into new section of ground G behind foreground plants FGP to support planter box 20 in an elevated different position at height H above ground G.

It is contemplated herein that portable and elevated planter box apparatus 10,10.1 can be easily incorporated into existing landscaping without damaging, modifying, or changing the existing landscaping.

It is further contemplated herein that portable and elevated planter box apparatus 10, 10.1 may be easily moved from one location to the next without damaging, modifying, or changing the existing landscaping.

It is still further contemplated herein that portable and elevated planter box apparatus 10, 10.1 may have elongated supports 50,50.1 of varying heights to change the height of portable and elevated planter box apparatus 10, 10.1 in the landscape.

With respect to the above description then, it is to be realized that the optimum dimensional relationships, to include variations in size, materials, shape, form, position, movement mechanisms, function and manner of operation, assembly and use, are intended to be encompassed by the present disclosure.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Moreover, the present disclosure has been described in detail, it should be understood that various changes, substitutions and alterations can be made thereto without departing from the spirit and scope of the disclosure as defined by the appended claims. Accordingly, the present disclosure is not limited to the specific embodiments illustrated herein but is limited only by the following claims.

1. An elevated planter apparatus positioned above ground, said apparatus comprising:
a planter box with sides and a bottom;
a plurality of aperture connectors connected to said bottom, each of said plurality of aperture connectors provides passageway therethrough;
a plurality of tube connectors having a closed end, each of said plurality of tube connectors connected to one of said plurality of aperture connectors; and
a plurality of rods having a first rod end and a second rod end, said first rod end positioned in the ground and said second rod end inserted in one of said plurality of aperture connectors and one of said plurality of tube connectors.

2. The apparatus of claim 1, wherein said plurality of aperture connectors further comprises a base and a stub configured perpendicular to said base.

3. The apparatus of claim 2, wherein said stub further comprises a first part of a connector system.

4. The apparatus of claim 3, wherein said plurality of plurality of tube connectors further comprises a second part of said connector system to engage said first part of said connector system about said bottom.

5. The apparatus of claim 3, wherein said connector system is threaded.

6. The apparatus of claim 1, wherein said plurality of rods is rebar.

7. The apparatus of claim 4, wherein said bottom further comprises a plurality of box apertures to receive said plurality of aperture connectors therethrough, said second part of said connector system to engage said first part of said connector system about said plurality of box apertures in said bottom.

8. The apparatus of claim 4, wherein said plurality of aperture connectors is formed integral to said bottom, said second part of said connector system to engage said first part of said connector system about said bottom.

9. An elevated planter apparatus positioned above ground, said apparatus comprising:
a planter box with sides having a rim therearound and a bottom;
a plurality of shepherd's hooks having a first hook end and a second hook end, said first hook end positioned in the ground;
a plurality of attachment devices, each of said plurality of attachment devices affixed to one of said plurality of shepherd's hooks between said first hook end and said second hook end; and
a plurality of connection systems, each of said plurality of connection systems removeably positioned between said each said plurality of attachment device and said rim of said planters box.

10. The apparatus of claim 9, wherein said each of said plurality of attachment devices further comprises a j-hook.

11. The apparatus of claim 9, wherein said each of said plurality connection systems further comprises a chain.

12. A method of elevating a planter having dirt and plants above ground in a landscape, said method comprising the steps of:
providing a planter box with sides and a bottom, a plurality of aperture connectors connected to said bottom, each of said plurality of aperture connectors provides passageway therethrough, a plurality of tube connectors having a closed end, each of said plurality of tube connectors connected to one of said plurality of aperture connectors, a plurality of rods having a first rod end and a second rod end, said first rod end positioned in the ground and said second rod end inserted in one of said plurality of aperture connectors and one of said plurality of tube connectors;
filing said planter box with the dirt and the plants;
inserting said second rod end in one of said plurality of aperture connectors and one of said plurality of tube connectors;
positioning said planter box in the landscape; and
inserting said first rod end in the ground.

13. The method of claim 12, repositioning said planter box in the landscape.

14. The method of claim 12, adjusting a height of said planter box in the landscape.
